(19) United States
(12) Patent Application Publication
(10) Pub. No.: US 2015/0232038 A1
(43) Pub. Date: Aug. 20, 2015

(54) ROOF RACK LEG FOR A ROOF RAIL

(71) Applicant: Hubco Automotive Limited, Auckland (NZ)

(72) Inventor: Bruce Robertson, Christchurch (NZ)

(73) Assignee: Hubco Automotive Limited, Auckland (NZ)

(21) Appl. No.: 14/421,813

(22) PCT Filed: Aug. 13, 2013
(86) PCT No.: PCT/NZ2013/000141

§ 371 Date: Feb. 13, 2015

(30) Foreign Application Priority Data
Aug. 14, 2012 (NZ) 601789

(51) Int. Cl. B60R 9/058; B60R 9/052

(52) U.S. Cl. CPC B60R 9/058; B60R 9/052

(57) ABSTRACT

Described herein is a roof rack leg or tower located between a roof rack cross bar and a vehicle rail including two opposing jaws, with the inner jaw having two degrees of movement. A rack incorporating the leg is also described.

### RELATED APPLICATIONS

This application derives priority from New Zealand patent application number 601789 incorporated herein by reference.

### TECHNICAL FIELD

Described herein is a roof rack leg for a roof rail. More specifically, a roof rack leg is described for connecting a roof rack crossbar to a roof rail on a vehicle and a roof rack incorporating the leg or legs.

### BACKGROUND ART

Sports equipment racks for vehicles typically include a pair of crossbars configured to extend across a vehicle roof width-wise for securing recreational equipment items. Typically, each crossbar is attached to the vehicle roof via a pair of legs also known as towers. For the purposes of this specification, the term ‘leg’ or ‘legs’ will be used although it should be appreciated that the terms ‘leg’, ‘tower’ or ‘foot’ may be used interchangeably.

Many different types of rack legs are known, and may be configured to be attached to a vehicle roof in any or a number of different ways. For example, some rack legs are configured for attachment to rain gutters. Others are designed for attachment to vehicle roof rails. Roof rails are elongate, linear, rigid structures mounted to the roofs of many vehicles, often by the vehicle manufacturer. A vehicle with roof rails typically has two rails running in parallel at least partially along the length of the roof. Roof rails may be raised or flush with respect to the vehicle roof.

One more recent variation in rail design are so called “flush rails”, which are relatively low and lie close to the vehicle. Often such flush rails do not include any gap under the rail meaning that roof rack attachment points need to clamp the roof rails on either side of the rails and not underneath the rail as occurs in many art designs. An example roof rack design to clamp a crossbar to vehicle rails is that published as WO94/214940. This patent publication describes a double clamp assembly using wedge shaped clamping jaws. The jaws move against each other for clamping around a roof rail via a clamping means.

Flush rails require special design considerations. Often such rails have a tapered shape along the roof of the vehicle with a width apart that narrows across the vehicle length reflecting the change in width of the vehicle roof to a narrow rear width. Rails may also be curved to suit the vehicle roof shape. A result of this design of rail is that the rail angle is not at right angles to the clamp jaws of a roof rack leg. This can result in difficulties achieving the desired strength of clamping on the rail in order to retain the roof rack (and any carried load) attached to the vehicle.

Flush rails also require the roof rack leg design to grip only the sides of the rail and not underneath the rail as often there is no gap between the rail and vehicle roof. This can considerably weaken the grip on the vehicle rail without a variation in design to cater for the changed grip required.

Further, with flush rails, it may be difficult to get the sufficient height/grip on the clamping jaws so that the load carrier bar can pass freely over the arched roof of the vehicle.

One of the problems in general with existing art legs for securing crossbars on top of vehicles is that the variability in rail configurations requires numerous different leg designs. This places a manufacturing and design burden on manufacturers, which increases product costs. The complexity of rail and leg designs also complicates the purchasing process for consumers who must determine which tower design is most appropriate for a given rail configuration. Consumers typically need to select from a range of leg designs configured to fit specifically small raised rails, large raised rails and flush rails. Reduction in the range of leg products required to fit various types of vehicle roof rails is useful to the customer, manufacturer and retailer.

Further aspects and advantages of the roof rack leg and rack will become apparent from the ensuing description that is given by way of example only.

### SUMMARY

Described herein is a roof rack leg between a roof rack cross bar and a vehicle rail, the leg including two opposing jaws that grip the rail, with the inner jaw having two degrees of movement. A rack incorporating the leg is also described along with a method of use.

In a first aspect, there is provided a roof rack leg linking a roof rack cross bar to a vehicle roof rail, the leg including:
(a) two opposing jaws being a movable inner jaw and a fixed position exterior jaw, both with internal facing surfaces that abut and clamp about opposing sides of a roof rail;
(b) a connecting means incorporating the jaws and linking the jaws to the roof rack cross bar; and
wherein the movable inner jaw has two degrees of movement being linear movement to and from the fixed exterior jaw and rotational movement of the inner jaw face relative to the face of the exterior jaw.

In a second aspect, there is provided a roof rack leg linking a roof rack cross bar to a vehicle roof rail, the leg including:
(a) two opposing jaws being a movable inner jaw and a fixed position exterior jaw both with internal facing surfaces that abut and clamp about opposing sides of a roof rail;
(b) a connecting means incorporating the jaws and linking the jaws to the roof rack cross bar about a threaded fastener, the fastener in turn being operatively linked to the inner and exterior jaws;
wherein the inner jaw links to the fastener about a jaw driver; and wherein, when rotated, the threaded fastener draws the jaw driver and movable inner jaw in a linear movement towards or away from the exterior jaw; and, wherein the jaw driver also acts as an orthogonal axis about which the inner jaw rotates allowing the inner face of the inner jaw to conform to the orientation of the vehicle rail side and allowing rotational movement independent of the face of the exterior jaw.

In a third aspect, there is provided a rack for carrying cargo on a vehicle, the vehicle having a pair of rails, the rails tapering in width from the front to the rear of the vehicle, the rack including:
a pair of crossbars, each crossbar having a pair of legs for mounting the crossbar on the rails of the vehicle;
each leg including two opposing jaws being a movable inner jaw and a fixed position exterior jaw both with internal facing surfaces that abut and clamp about opposing sides of a roof rail; a connecting means incorporating the jaws and linking the jaws to the roof rack cross bar; and
wherein the movable inner jaw has two degrees of movement being linear movement to and from the fixed exterior jaw and rotational movement of the inner jaw face relative to the face of the exterior jaw.

### BRIEF DESCRIPTION OF THE DRAWINGS

Further aspects of the roof rack leg and rack will become apparent from the following description that is given by way of example only and with reference to the accompanying drawings in which:

FIG. 1 illustrates a perspective view of one embodiment of the rack and leg attached to a vehicle roof rail;

FIG. 2 illustrates a perspective view of the underside of the roof rack leg with the rack and vehicle rail removed for clarity;

FIG. 3 illustrates an underside view of the roof rack leg attached to a crossbar showing the different positions of rotation of the inner jaw; and

FIG. 4 illustrates a cross-section view of the roof rack leg about line AA shown in FIG. 3.

### DETAILED DESCRIPTION

As noted above, a roof rack leg is described located between a roof rack cross bar and a vehicle rail, the leg including two opposing jaws, with the inner jaw having two degrees of movement. A rack incorporating the leg is also described.

For the purposes of this specification, the term ‘about’ or ‘approximately’ and grammatical variations thereof mean a quantity, level, degree, value, number, frequency, percentage, dimension, size, amount, weight or length that varies by as much as 30, 25, 20, 15, 10, 9, 8, 7, 6, 5, 4, 3, 2, or 1% to a reference quantity, level, degree, value, number, frequency, percentage, dimension, size, amount, weight or length.

The term ‘substantially’ or grammatical variations thereof refers to at least about 50%, for example 75%, 85%, 95% or 98%.

For the purpose of this specification the term ‘comprise’ and grammatical variations thereof shall have an inclusive meaning—i.e. that it will be taken to mean an inclusion of not only the listed components it directly references, but also other non-specified components or elements.

The term ‘rail’ or grammatical variations thereof refers to a raised projection from the roof surface of a vehicle generally extending along a portion or all of the sides of a vehicle.

The term ‘inner’ or grammatical variations thereof refers to the orientation of a surface relative to a person standing on the side of a vehicle with the inner surface or jaw of a leg being located towards the vehicle roof and away from the outer side of the vehicle when viewed in a horizontal plane.

The term ‘exterior’ or grammatical variations thereof refers to the orientation of a surface relative to a person standing on the side of a vehicle with the exterior surface or jaw of a leg being located towards the outer side of the vehicle and away from the vehicle roof when viewed in a horizontal plane.

The term ‘side’ or grammatical variations thereof, in the context of a vehicle rail refers to the lateral or approximately lateral surfaces of the rails (as opposed to the front, back, top or bottom if visible of the rail(s)).

The term ‘front of vehicle’ or grammatical variations refers to the end of the vehicle that is in the normal direction of travel of the vehicle (not a reverse direction of travel).

The term ‘rear of vehicle’ or grammatical variations refers to the end of the vehicle that is in the reverse direction of travel of the vehicle (not a normal direction of travel).

In a first aspect, there is provided a roof rack leg linking a roof rack cross bar to a vehicle roof rail, the leg including:
(a) two opposing jaws being a movable inner jaw and a fixed position exterior jaw, both with internal facing surfaces that abut and clamp about opposing sides of a roof rail;
(b) a connecting means incorporating the jaws and linking the jaws to the roof rack cross bar; and
wherein the movable inner jaw has two degrees of movement being linear movement to and from the fixed exterior jaw and rotational movement of the inner jaw face relative to the face of the exterior jaw.

The inventors have found that by having two degrees of movement of the inner jaw, a bigger proportion of the jaw is able to abut the rail side irrespective of rail tapering angle or rail curvature meaning a greater grip surface is achieved.

Rotational movement of the inner jaw is particularly advantageous. Rotational movement is relative to the exterior jaw in an approximately horizontal plane where the term ‘approximately’ in this context refers to the plane being either in a purely horizontal plane (i.e. 0 degrees offset) or up to 5, 10, 15, 20, 25, or 30 degrees offset from a purely horizontal plane. The degree of offset from a purely horizontal plane may in part be defined by the angle of the rail, curvature of the rail and design considerations in the leg itself. For example, the exterior jaw may be seated higher than the inner jaw due to the rail being angled towards the inner portion (roof area) of the vehicle.

The vehicle roof rail may be a flush rail. As noted above, so called ‘flush rails’ present a greater degree of difficulty in roof rack leg design as the grip surface is smaller than other types of design and often there is no gap under the rail hence the attachment point or points are the sides of the rail(s). Flush rails may also be interchangeably referred to in the art as ‘integrated rails’. It should however be appreciated that the above leg design, while useful for flush rails, may also be used with other types of vehicle rails.

The vehicle roof rail may have an undercut on the exterior side of the roof rail. Other contours such as protrusions, dips, cut outs and the like may also exist on the rail sides depending on the vehicle manufacturer. The jaws described herein may be shaped to directly or indirectly (such as via an insert) complement the contours of the rail.

The connecting means may be a moulding made from a plastic, elastomer or metal.

The exterior jaw may be integral to the connecting means. While separate embodiments are also encompassed herein, the exterior jaw may be integral to a moulding that receives and retains the cross bar and other items forming the leg. By way of example, the exterior jaw may be a separate item fitted to the moulding via a mechanical fastener or fasteners.

The inner face of the exterior jaw may have similar contours to the side of the rail to which the exterior jaw abuts. The term ‘inner face of the exterior jaw’ refers to the face of the exterior jaw that abuts the rail or the face that, via another item such as an insert, abuts the rail. As noted above, the rail may have varying contours and shapes and it is useful to complement this shape on the exterior jaw face in part or in full in order to maximise the surface area abutting the rail side.

The inner face of the exterior jaw may have an insert located between the exterior jaw face and the vehicle roof rail side. Use of an insert may enhance the grip of the jaw against the side of the rail by providing a greater contact area and, through use of high friction materials in the insert, the grip strength may also be increased.

The pad may be manufactured from a plastic, elastomer or metal material. In one embodiment the insert may be a rubber based insert. A rubber insert may be useful to prevent aesthetic damage to the vehicle rail or rails particularly on the more visible exterior sides. The rubber insert may be manufactured from a thermoplastic vulcanizate (TPV). One commercially available example TPV may be Santoprene™. It should be appreciated that other types of rubber may also be used.

The insert may be shaped to match the profile and tapering of the rail. As noted above, the contours of the rail may vary hence it is helpful to also provide a complementary insert surface.

The insert may extend to at least cover a portion of the top surface of the rail as well as the side of the rail. Extension to some or the entire top region of the rail also may assist to prevent any aesthetic damage to the top of the rail.

The insert may be removable and/or affixed to the jaw or jaws.

The inner jaw may have an approximately C-shaped cross-section wherein, one end of the inner jaw fastens to the connecting means and the other end of the inner jaw abuts and clamps the side of the vehicle rail. The C-shape may be formed in three folds where the angle of the face of the inner jaw that abuts the rail runs in parallel with the angle of the rail when viewed in a vertical plane. Whilst not essential, having folds may increase the surface area abutting the rail thereby increasing the grip strength of the leg on the rail.

The connecting means may incorporate a clamping means linking the inner and exterior jaws. The clamping means may be a threaded fastener. When rotated, the threaded fastener may draw the inner jaw toward or away from the exterior jaw in a linear movement. The inner jaw may link to the fastener about a jaw driver and the jaw driver translates rotational movement of the fastener to linear movement of the inner jaw.

The jaw driver may also have a further function of acting as an orthogonal axis about which the inner jaw rotates allowing the inner face of the inner jaw to conform to the direction of the side of the vehicle rail and allowing rotational movement independent of the face of the exterior jaw.

The connecting means may include a stop or stops to prevent excess rotational movement of the inner jaw. The stop or stops may be protrusions integral to and projecting from the connecting means or moulding.

The inner jaw may be manufactured from an alloy. The alloy may be a stainless steel. The face of the inner jaw that abuts the vehicle rail may have a high friction coating. The entire inner jaw may have a high friction coating. The high friction coating may be a PVC coating.

The inner jaw may have a pin or pins protruding from the inner face of the inner jaw that correspond and are received within complementary holes in the vehicle rail. Some vehicle manufacturers include a location hole or holes on the inside of the rail. In these cases, the inner jaw may have a complementary pin or pins that fit and help to locate the leg onto the rail. As should be appreciated, the pin may be sized to have a diameter approximately the same as that of the hole in the rail. The pin may be approximately 1, or 2, or 3, or 4, or 5, or 6, or 7, or 8, or 9, or 10 mm in diameter and the pin may be approximately 1, or 2, or 3, or 4, or 5, or 6, or 7, or 8, or 9, or 10 mm long.

In a second aspect, there is provided a roof rack leg linking a roof rack cross bar to a vehicle roof rail, the leg including:
(a) two opposing jaws being a movable inner jaw and a fixed position exterior jaw both with internal facing surfaces that abut and clamp about opposing sides of a roof rail;
(b) a connecting means incorporating the jaws and linking the jaws to the roof rack cross bar about a threaded fastener, the fastener in turn being operatively linked to the inner and exterior jaws;
wherein the inner jaw links to the fastener about a jaw driver; and
wherein, when rotated, the threaded fastener draws the jaw driver and movable inner jaw in a linear movement towards or away from the exterior jaw; and, wherein the jaw driver also acts as an orthogonal axis about which the inner jaw rotates allowing the inner face of the inner jaw to conform to the orientation of the vehicle rail side and allowing rotational movement independent of the face of the exterior jaw.

In a third aspect, there is provided a rack for carrying cargo on a vehicle, the vehicle having a pair of rails, the rails tapering in width from the front to the rear of the vehicle, the rack including:
a pair of crossbars, each crossbar having a pair of legs for mounting the crossbar on the rails of the vehicle;
each leg including two opposing jaws being a movable inner jaw and a fixed position exterior jaw both with internal facing surfaces that abut and clamp about opposing sides of a roof rail; a connecting means incorporating the jaws and linking the jaws to the roof rack cross bar; and
wherein the movable inner jaw has two degrees of movement being linear movement to and from the fixed exterior jaw and rotational movement of the inner jaw face relative to the face of the exterior jaw.

Advantages of the above leg design are that the leg may be used on a variety of vehicles due to the ability to rotate the inner jaw thus being able to cater for a wide range of vehicles types. The design also avoids having to redesign the leg for each vehicle as variation of the exterior jaw inner face contours or rubber insert contours may easily be completed whilst not having to alter other parts. The design is also strong and is capable of meeting safety standards such as the so-called ‘City Crash’ test and DIN standards.

The embodiments described above may also be said broadly to consist in the parts, elements and features referred to or indicated in the specification of the application, individually or collectively, and any or all combinations of any two or more said parts, elements or features, and where specific integers are mentioned herein which have known equivalents in the art to which the embodiments relates, such known equivalents are deemed to be incorporated herein as of individually set forth,

Where specific integers are mentioned herein which have known equivalents in the art to which this invention relates, such known equivalents are deemed to be incorporated herein as if individually set forth.

### WORKING EXAMPLE

The above described roof rack leg and rack are now described by reference to a specific example.

### Example 1

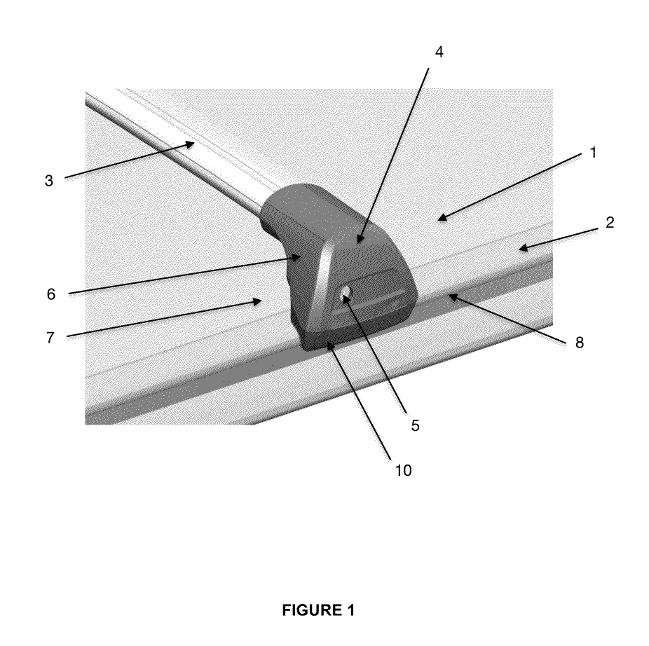

Referring to FIG. 1, the roof rack leg generally indicated by arrow 1 is shown in an assembled form attached to a vehicle roof rail 2. The leg 1 presents a clean form with all parts housed within a moulding 6 and a removable cover 4. The leg 1 links the rail 2 with a crossbar 3. Terms such as ‘inner’ and ‘exterior’ used in this example refer to the position of the leg relative to the vehicle with the vehicle roof side 7 being the inner region and the vehicle exterior side 8 being the exterior.

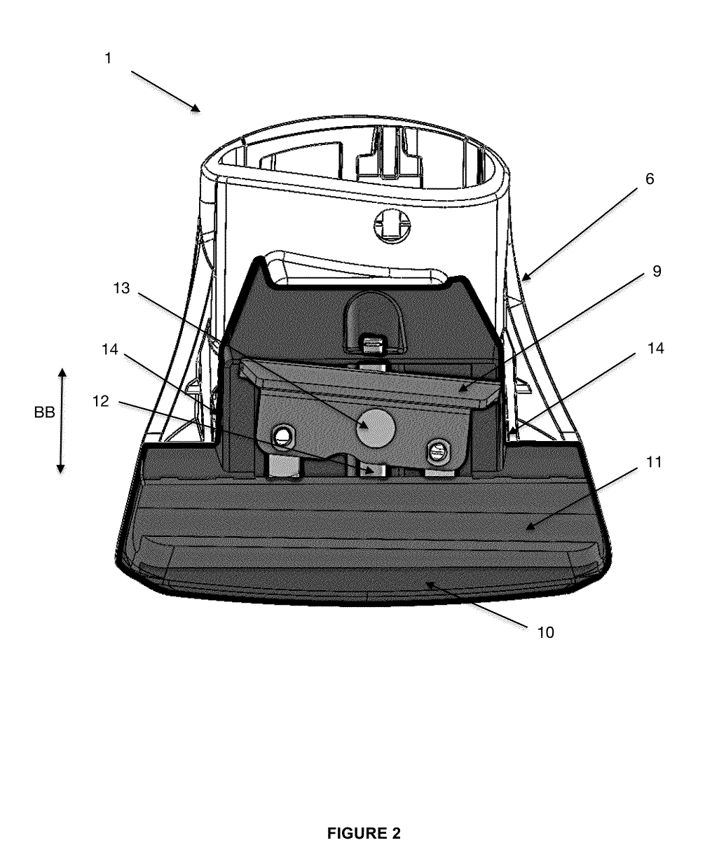

FIG. 2 shows the leg 1 in more detail. The view is of the leg 1 underside and shows the inner jaw 9 positioned apart from the exterior jaw 10. The leg 1 as shown incorporates a moulding 6 to which an exterior jaw 10 is linked. The exterior jaw 10 in the embodiment shown has a rubber insert 11 attached to it and the rubber insert 11 abuts the rail 2 side. The insert 11 may also not be used and instead the exterior jaw 10 itself may abut the rail 2. Use of a rubber insert 11 is advantageous as it allows the production of various insert 11 shapes in a cost effective manner shaped to specifically fit each vehicle type. The cost of such inserts 11 is relatively small and they can easily be interchanged with the exterior jaw 10 to suit the vehicle to which the leg 1 is fitted. The rubber insert 11 may be manufactured from high friction materials such as thermoplastic vulcanizate (TPV), one example being Santoprene™.

The inner jaw 9 may be manufactured in a C-cross section shape, one end abutting the rail 2 and the other end being linked to a clamping means 12 which in the embodiment shown is a threaded fastener 12. The inner jaw 9 may be manufactured from stainless steel and may have a partial to full high friction coating so as to ensure a tight fit against the rail 2. The coating may only be on the face abutting the rail 2 or may be over the whole piece forming the inner jaw 9. The coating may be a PVC coating. The inner jaw 9 is moveable relative to the exterior jaw 10 in a linear direction generally indicated by arrow BB in FIG. 2. Linear movement of the inner jaw 9 is driven by rotational movement of the threaded fastener 12 which in turn drives a jaw driver 13 pulling the inner jaw 9 either towards the exterior jaw 10 (and rail 2 when the leg is placed over a rail 2) or away from the exterior jaw 10 or rail 2 depending on the direction of rotation and direction of thread on the fastener 12.

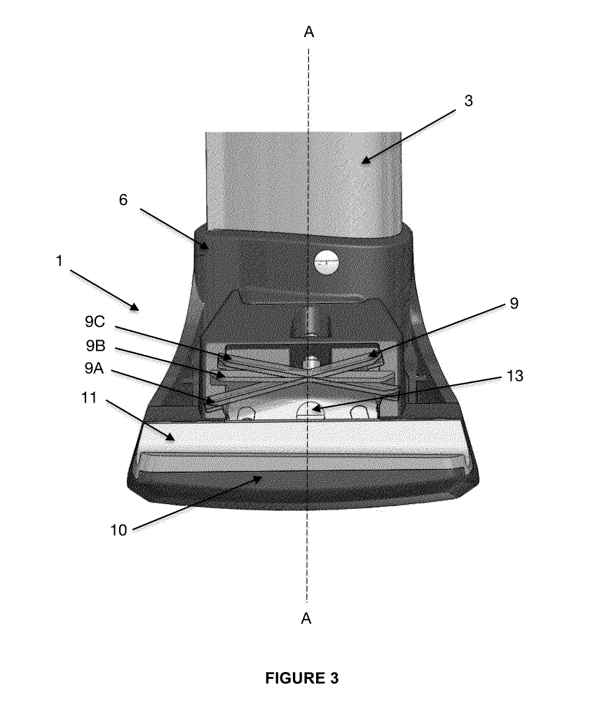

The inner jaw 9 is also able to move rotationally in an approximately horizontal plane (0 degrees to 30 degrees offset from a horizontal plane) about an axis defined by the jaw driver 13. As best viewed in FIG. 3, the inner jaw 9 is able to rotatably move about the jaw driver axis 13 in various orientations relative to the exterior jaw 10 and insert 11. FIG. 3 illustrates three different positions for the inner jaw 9 being 9A through to 9C showing the varying extremes of rotation possible. This rotation allows the inner jaw to be able to clamp varying tapered faces of vehicle rails 2. Many modern rails 2 have some quite extreme tapering and/or curvature of the rail 2 sides from the front to the back of the vehicle making it difficult to secure a leg 1 to rail 2, particularly when the rack leg 1 is only able to grasp the sides of the rail 2 and not underneath the rail 2 as can often be the case for flush rail 2 designs. By allowing rotation, the best possible grip is achieved by placing as much of the jaw 9 face on the rail 2 side as possible. The exterior jaw 10 face and/or the rubber insert 11 may also be tapered again to ensure as much grip surface on the rail 2 side as possible. The moulding 6 may also incorporate a stop or stops 14 to prevent excessive rotation of the inner jaw 9.

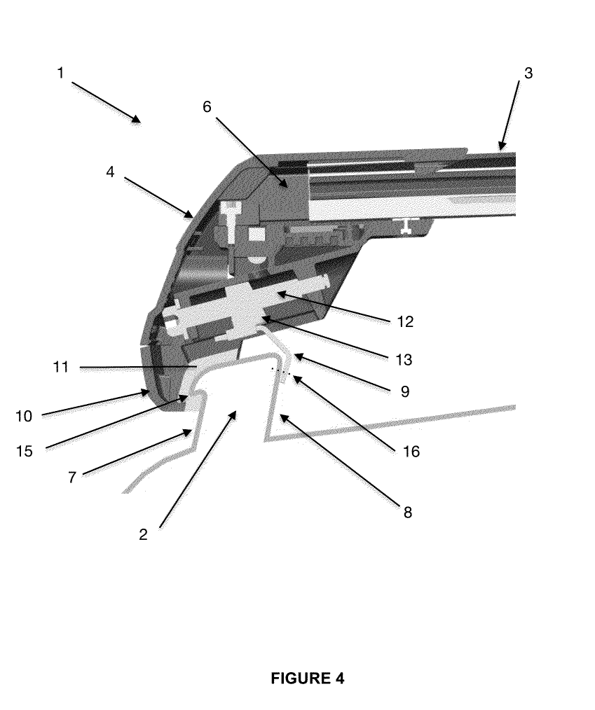

FIG. 4 illustrates the roof rack leg 1 in cross-section about line AA in FIG. 3. In this view, the rail 2 detail can be seen more clearly. The rail 2 may have an undercut 15 as illustrated helping to assist with attachment of the leg 1 to the rail 2. The C-shape cross-section of the inner jaw 9 is also more clearly illustrated. The jaw driver 13 is also shown. The driver may be a rectangular block shaped to fit a recess in the moulding 6 through which the threaded fastener passes via a complementary thread on the jaw driver 13. The jaw driver 13 is linked to the inner jaw 9 and translates rotational movement of the threaded fastener 12 into linear movement of the inner jaw 9. The jaw driver 13 also acts as an orthogonal axis about which the inner jaw may rotate in an approximately horizontal plane (0 to 30 degrees offset from a purely horizontal plane). Also visible more clearly in FIG. 4 is the rubber insert 11 cross-section. The insert may have a shape that complements the shape of the rail 2, in the embodiment shown the insert also has an under cut to match the rail under cut 15. The insert 11 may extend around the top of the rail 2 to ensure the high friction surface of the rubber insert 11 also abuts the top of the rail 2.

Finally, as shown in FIG. 4 via dotted line 16, the inner jaw 9 may have a pin or pins protruding from the inner face of the inner jaw 9 that correspond and are received within complementary holes in the vehicle rail 2. Some vehicle manufacturers include a location hole or holes on the inside of the rail 2 and in these cases, the inner jaw 9 may have complementary pins 16 that fit and help to locate the leg 1 onto the rail 2. In one embodiment, the hole and pin may be approximately 1 to 10 mm in diameter and the pin may be approximately 1 to 10 mm long.

To summarise, the above example embodiment, a roof rack leg 1 is described for linking a roof rack cross bar 3 to a vehicle roof rail 2. The leg 1 includes two opposing jaws being a movable inner jaw 9 and a fixed position exterior jaw 10 both with internal facing surfaces that abut and clamp about opposing sides of a roof rail 2. The movable inner jaw 9 has two degrees of movement being linear movement (shown as arrow BB in FIG. 2), to and from the fixed exterior jaw 10 and rotational movement (shown as positions 9A, 9B and 9C) of the inner jaw 9 relative to the face of the exterior jaw 10.

A rack for carrying cargo on top of a vehicle with rails 2 is also incorporated within this example. The rack may include a pair of crossbars 3, each crossbar 3 having a pair of legs 1 described above for mounting the crossbar 3 on the rails 2 of the vehicle.

The leg 1 and rack incorporating the leg 1 or legs 2 may be advantageous as they provide a secure way of attaching a rack to a vehicle with rails including vehicles with flush rails. The two degrees of rotation allowed for in the inner jaw 9 allows for more tolerance in terms of tapering of the rails 2 meaning less re-design and re-tooling for different vehicle types. The one part that may be interchanged for different vehicles can be the rubber insert 11 which is easy to mould to suit the specific rail 2 shape for a vehicle and which is inexpensive to mass produce and fit to the rest of the leg assembly as needed thereby minimising equipment costs while maximising potential market opportunity.

Aspects of roof rack leg and rack have been described by way of example only and it should be appreciated that modifications and additions may be made thereto without departing from the scope of the claims herein.

1. A roof rack leg linking a roof rack cross bar to a vehicle roof rail, the leg comprising:
(a) two opposing jaws being a movable inner jaw and a fixed position exterior jaw, both with internal facing surfaces that abut and clamp about opposing sides of a roof rail;
(b) a connecting means incorporating the jaws and linking the jaws to the roof rack cross bar; and
wherein the movable inner jaw has two degrees of movement being linear movement to and from the fixed exterior jaw and rotational movement of the inner jaw face relative to the face of the exterior jaw.

2. The roof rack leg as claimed in claim 1 wherein the vehicle roof rail is a flush rail.

3. The roof rack leg as claimed in claim 1 wherein the vehicle roof rail has an undercut on the exterior side of the roof rail.

4. The roof rack leg as claimed in claim 1 wherein the exterior jaw is integral to the connecting means.

5. The roof rack leg as claimed in claim 1 wherein the face of the exterior jaw has similar contours to the side of the rail to which the exterior jaw abuts.

6. The roof rack leg as claimed in claim 1 wherein the face of the exterior jaw has an insert located between the exterior jaw face and the vehicle roof rail side.

7. The roof rack leg as claimed in claim 6 wherein the insert is shaped to match the profile and tapering of the rail.

8. The roof rack leg as claimed in claim 6 wherein the insert extends to at least cover a portion of the top surface of the rail as well as the side of the rail.

9. The roof rack leg as claimed in claim 6 wherein the insert is manufactured from a thermoplastic vulcanizate (TPV).

10. The roof rack leg as claimed in claim 1 wherein the inner jaw has an approximately C-shaped cross-section wherein, one end of the inner jaw fastens to the connecting means and the other end of the inner jaw abuts and clamps the side of the vehicle rail.

11. The roof rack leg as claimed in claim 1 wherein the connecting means incorporates a threaded fastener.

12. (canceled)

13. The roof rack leg as claimed in claim 11 wherein, when rotated, the threaded fastener draws the inner jaw toward or away from the exterior jaw in a linear movement.

14. The roof rack leg as claimed in claim 11 wherein the inner jaw links to the fastener about a jaw driver and the jaw driver translates rotational movement of the fastener to linear movement of the inner jaw.

15. The roof rack leg as claimed in claim 14 wherein the jaw driver acts as an orthogonal axis about which the inner jaw rotates allowing the inner face of the inner jaw to conform to the direction of the side of the vehicle rail and allowing rotational movement independent of the face of the exterior jaw.

16. The roof rack leg as claimed in claim 1 wherein the connecting means includes a stop or stops to prevent excess rotational movement of the inner jaw.

17. The roof rack leg as claimed in claim 1 wherein the inner jaw is manufactured from an alloy and the face of the inner jaw that abuts the vehicle rail has a high friction coating.

18. The roof rack leg as claimed in claim 17 wherein the high friction coating is a PVC coating.

19. The roof rack leg as claimed in claim 1 wherein the inner jaw has a pin or pins protruding from the inner face of the inner jaw that correspond and are received within complementary holes in the vehicle rail.

20. A roof rack leg linking a roof rack cross bar to a vehicle roof rail, the leg comprising:
(a) two opposing jaws being a movable inner jaw and a fixed position exterior jaw both with internal facing surfaces that abut and clamp about opposing sides of a roof rail;
(b) a connecting means incorporating the jaws and linking the jaws to the roof rack cross bar about a threaded fastener, the fastener in turn being operatively linked to the inner and exterior jaws;
wherein the inner jaw links to the fastener about a jaw driver; and
wherein, when rotated, the threaded fastener draws the jaw driver and movable inner jaw in a linear movement towards or away from the exterior jaw; and, wherein the jaw driver also acts as an orthogonal axis about which the inner jaw rotates allowing the inner face of the inner jaw to conform to the orientation of the vehicle rail side and allowing rotational movement independent of the face of the exterior jaw.

21. A rack for carrying cargo on a vehicle, the vehicle having a pair of rails, the rails tapering in width from the front to the rear of the vehicle, the rack comprising:
a pair of crossbars, each crossbar having a pair of legs for mounting the crossbar on the rails of the vehicle;
each leg including two opposing jaws being a movable inner jaw and a fixed position exterior jaw both with internal facing surfaces that abut and clamp about opposing sides of a roof rail; a connecting means incorporating the jaws and linking the jaws to the roof rack cross bar; and
wherein the movable inner jaw has two degrees of movement being linear movement to and from the fixed exterior jaw and rotational movement of the inner jaw face relative to the face of the exterior jaw.
